(19) United States
(12) Patent Application Publication
(10) Pub. No.: US 2012/0051726 A1
(43) Pub. Date: Mar. 1, 2012

(54) APPARATUS, SYSTEMS, AND METHODS FOR EMULATING EXAMPLE PHOTOGRAPHS

(76) Inventor: KEVIN J. KING, VANCOUVER, WA (US)

(21) Appl. No.: 13/223,105

(22) Filed: Aug. 31, 2011

Related U.S. Application Data
(60) Provisional application No. 61/378,887, filed on Aug. 31, 2010.

(51) Int. Cl. G03B 15/02; G03B 15/00

(52) U.S. Cl. 396/4; 396/1

(57) ABSTRACT

Methods for emulating an example photograph with an imaging system include selecting an example photograph from a database of image profiles each including information related to a photographic setup, including one or more settings for equipment therein, for taking the example photograph, determining, from information in the corresponding image profile, a value for a parameter of a device of the imaging system, and transmitting, to the device, a command signal to set the parameter of the device to the determined value. Search queries of the database may be based on equipment of, or available for use with, the imaging system, to return a set of example photographs achievable with the capabilities of the equipment. A commander device includes a command module to retrieve information from such a database and determine therefrom suitable values for imaging system equipment, and a transmission module to transmit corresponding command signals to imaging system equipment.

### RELATED APPLICATION

This application claims the benefit of U.S. Provisional Application No. 61/378,887, filed on Aug. 31, 2010, the entire disclosure of which is incorporated herein by reference for all purposes.

### TECHNICAL FIELD

This disclosure relates to control of settings in an imaging system, and in particular to systems, methods, and apparatus for emulating an example photograph with an imaging system.

### BACKGROUND

Photographers of all skill levels must consider many technical factors when planning a photograph, even with a good idea in mind of how the photograph should appear or should be composed. For example, a variety of lighting issues are present in various photographic environments, whether indoor (e.g., in a studio, or otherwise) or outdoor, that should be addressed in terms of how best to achieve a desired look or feel for a photograph. Some issues relate to number, type, position, orientation, flash intensity, and so forth, of various lighting devices that may be employed in an imaging system.

With so many variables to consider, it can sometimes be difficult for a photographer to decide which pieces of photographic equipment should be used, and/or how their respective settings should be adjusted or set, in order to achieve a goal. It is common for many photographers to refer to an existing photograph, or photographs, as examples or references for factors such as lighting, positioning of a photographic subject against a background, presence of other objects in a photographic composition, and other variables that have an affect on the overall photograph. Clients and/or models also find it helpful to refer to an existing photograph when discussing the desired result of a photo shoot with a photographer.

### SUMMARY

The systems, methods, and apparatus disclosed herein provide various means to assist a photographer to emulate an example photograph with a photographic system (or other imaging system, such as a videographic system) having one or more devices, such as a lighting device or otherwise, that has an adjustable parameter (for example, the flash intensity value of a lighting device) used during image acquisition by the system.

In some embodiments in accordance with the systems, methods, and apparatus disclosed herein, a commander device communicates with one or more pieces of photographic equipment (e.g., a camera or other imaging apparatus, one or more flash or other lighting devices, etc.) of a user's imaging system. As explained in greater detail below, the user experience in such example embodiments typically involves accessing a database of image profiles, each of which includes an image of an example photograph and various data related thereto, such as information relating to photographic equipment suitable for taking the example photograph (which may be the actual photographic equipment used in taking the photograph, a virtual photographic setup, and so forth), and settings for the photographic equipment. When an example photograph is selected, for example by indexing through images of example photographs of image profiles in the database, such embodiments may provide various information to the user, relating to the example photograph, that is based on data from the corresponding image profile. This information may be presented in various forms, such as text instructions and/or schematic diagrams for setting up and orienting pieces of photographic equipment (e.g., a camera or other imaging apparatus, flash or other lighting devices, etc.), relative to the photographic subject, and so forth. Moreover, in such embodiments, the commander device may determine, from the image profile data, one or more values for adjustable parameters of various pieces of photographic equipment of the imaging system in use (for example, a value for the flash intensity setting of a flash device, a ratio for the flash intensity values of two flash devices, etc.) that are consistent with that of the image profile, and communicate one or more command signals to the photographic equipment that are configured to set the parameters of the photographic equipment to those values, in order to assist in emulating the example photograph. In some embodiments, information about the devices of the photographic system that the photographer intends to use may be used as the basis of a search query of the database, for example to return a set of results that represent example photographs that the photographic system in use are capable of achieving. In some embodiments, this information may be supplemented with various information relating to the photographic environment, and so forth.

Thus, in accordance with the present disclosure, an illustrative method for emulating an example photograph with an imaging system adapted for image acquisition of a subject in an environment may include selecting an example photograph from a database of image profiles, then determining, from information in the image profile corresponding to the example photograph, at least one value for a parameter of a device of the imaging system, to emulate the photographic setup for taking the example photograph. The method may proceed by transmitting, to the device, a command signal configured to set the parameter of the device to the determined value. In some embodiments, the illustrative method may further include, such as prior to determining the value(s) for the parameter(s) of the device(s), accepting an inventory of devices available for inclusion in the imaging system. In such embodiments, the illustrative method may further include identifying one or more of the devices from the inventory to include in the imaging system during image acquisition (and including such identified devices in the determination of at least one parameter value). Optionally, in such embodiments, the inventory of devices may function as search parameters for searching the database of image profiles, such as to focus the available image profiles to those that may be compatible with the inventory of devices available for inclusion in the imaging system. In other embodiments, the existing devices of the imaging system, or information related thereto, may function as search parameters for searching the database of image profiles, such as to focus the available image profiles to those that may be compatible with the existing imaging system. Other search parameters may include various information about the environment, such as that may be accepted in addition to the device inventory.

An illustrative system, in accordance with the present disclosure, may be embodied in one or more devices or components, and may be configured to assist emulation of an example photograph with an imaging system. An example embodiment of such a system includes a database of image profiles, selection means for searching the database and selecting an example photograph therefrom, processing means for determining, from data in a image profile corresponding to the example photograph, a value for a parameter of a device of the imaging system than is consistent with the data (such as photographic settings, etc.) of the image profile, for taking the example photograph, and transmission means for transmitting a command signal configured to set the parameter of the device to the determined value.

An illustrative apparatus in accordance with the present disclosure may be a commander device that includes a command module configured to retrieve information from an image profile corresponding to a selected example photograph from a database of image profiles, and to determine at least one value for an adjustable parameter of a device of a imaging system to emulate the photographic setup for taking the selected example photograph. Such a commander device may further include a transmission module configured to transmit a command to signal to the device that is configured to set the adjustable parameter to the determined value. In some embodiments, the commander device is configured to be removably coupled to a camera or other imaging apparatus of the imaging system, such as via a hotshoe connector. In some embodiments, the commander device includes a display module.

The concepts, features, methods, and component configurations briefly described above are clarified with reference to the accompanying drawings and detailed description below.

### BRIEF DESCRIPTION OF THE DRAWINGS

FIG. 1 shows a schematic view illustrating a first example imaging system that includes a camera and two remote flash devices arranged relative to a photographic subject. An illustrative embodiment of a commander device constructed in accordance with aspects of the present disclosure is shown to be coupled to the camera. The commander device is also shown to include a database of image profiles.

FIG. 2 is a schematic view illustrating the internal layout of various components of the illustrative embodiment of the commander device of FIG. 1.

FIG. 3 shows a schematic view illustrating a second example imaging system that includes a camera, a local flash device coupled thereto, and two remote flash devices, arranged relative to a photographic subject. A second illustrative embodiment of a commander device is shown to be coupled to the camera and local flash device. A computing device that includes a database of image profiles is in communication with the commander device.

FIG. 4 shows a schematic view illustrating a third example imaging system somewhat similar to that in FIG. 3. A third illustrative embodiment of a commander device, shown coupled to the camera and a local flash device, communicates with a database of image profiles accessible via a network and a computing device.

FIG. 5 shows a schematic view illustrating a fourth example imaging system somewhat similar to that in FIGS. 3 and 4. A fourth illustrative embodiment of a commander device, shown coupled to the camera, communicates with a communication device, which in turn communicates with a database of image profiles accessible via a network.

FIG. 6 shows an illustrative example of a schematic diagram, depicting a three-dimensional view of an example photographic setup, that may be presented on a display to user after selecting an example photograph.

FIG. 7 shows another illustrative example of a schematic diagram, depicting a top view of the schematic diagram of FIG. 6.

FIG. 8 shows another illustrative example of a schematic diagram, depicting a front view of the schematic diagram of FIG. 6.

FIG. 9 shows another illustrative example of a schematic diagram, depicting a simplified top view of the schematic diagram of FIG. 6.

### DETAILED DESCRIPTION

In each of the several example imaging systems described herein, an imaging system includes an imaging apparatus in the form of a camera and one or more lighting devices, such as flash devices, for use with the camera in image acquisition of (or, in the example environments discussed herein, photographing) a subject. However, it will be clear that the example devices shown and discussed in the example imaging systems are for purposes of illustration of various aspects of the systems, methods, and apparatus of the present invention, which are suitable for use in, or with, imaging systems that may include any quantity and type of equipment for image acquisition. For example, in some embodiments, an imaging system may be a videographic system rather than a photographic system, or include videographic as well as photographic components and/or equipment, and so forth. As such, although the various terminology used in the description may specifically refer to photographic systems, equipment, and devices, the concepts discussed herein are applicable to any system suitable to acquire an image of a subject.

As such, the general term “imaging environment” as well as the more specific term “photographic environment” (which may be used interchangeably, when discussing the example imaging environments) refer to an environment in which images of a subject may be acquired. Typically, the environment includes various pieces of imaging equipment (e.g., part or all of the imaging system in use), the subject of the image acquisition (e.g., to be photographed), objects in the environment (such as a background and/or background elements, various other items), the environment itself (for example, a foggy outdoor setting), and other factors, each of which contribute to making a particular image, such as a photographic image. A discrete item in a photographic environment may be referred to herein as an “element.” Examples of elements in the form of equipment may include flash equipment such as flash devices, reflectors, diffusers, soft boxes, color gels, other lighting equipment, camera (or other imaging apparatus) equipment such as a stand, etc. Subject-related elements may include one or more people, objects, clothing, etc.; environment-related elements may include walls, windows, a ceiling, a floor or another ground surface, natural setting elements such as the sky, a cloud formation, mountains, a beach, a body of water, trees, etc.

Elements of the photographic environment may be defined, described, characterized, etc., in terms of various parameters. A parameter is a quantifiable or qualifiable value that an element may have. Parameters may be specific to the element, and may describe capabilities, such as states that a particular element is capable of achieving, or settings, such as values that may be adjusted or set, such as by a user. Example setting parameters for equipment-related elements may include power settings, placement in space relative to a subject, angle of coverage (e.g. for a flash device), orientation (e.g., of a flash device, such as measured relative to a reference plane). Example capability parameters for a lighting device, for example, may include its maximum power value, its minimum power value, whether it is (or may be operated as) a constant light source or an intermittent one, its average recycle time, its angle of coverage, etc. Example capability parameters for a reflector, for example, may include its color, its size, its shape, its reflectivity, and so forth, whereas example setting parameters may include a distance from a reference location on the reflector to the subject or to one or more flash devices, the angle of the reflector with respect to the subject, etc.

Further, some equipment may be modified with other equipment, and such modifications may be described in terms of setting parameters. For example, a lighting device modified with items such as a soft box, or a snoot, or some other means of directing, shaping, or modifying the light from the lighting device, may be described as a lighting device having the setting parameter “with a soft box” or “with a snoot,” and so forth. Another example may be a flash device having the setting parameter “with a reflector.” The environment-related element “available sunlight” may be modified with the setting parameter “reflected toward subject.” Parameters may be organized into general categories, such as equipment-based, subject-based, and so forth.

In this or a similar manner, information about a particular photographic setup and/or equipment that is used to take a photograph, including various settings related to the subject and/or other elements in the environment, may be arranged and/or articulated in a somewhat standardized way, for example to serve as an example that another photographer may attempt to emulate by means of replicating one or more of the parameters used for the reference photograph. In other words, a photographer may emulate a reference (or “example”) photograph by emulating one or more aspects of the photographic setup used in capturing the photograph. As used herein, the term “image profile” is used to refer to some or all of the aforementioned information that may be associated with a photograph. For example, an image profile may include an image (or more than one) of the photograph, a list of the equipment used (or “photographic setup”) to take the photograph, a group of setting parameters and/or capability parameters (also referred to collectively as “settings”) for some or all of the equipment, descriptions (in terms of parameters) of other elements of the environment, and so forth.

An image profile may be compiled in different manners. Typically, all or some of the information in an image profile may be that recorded by the photographer during image acquisition of a subject in the creation of a photograph. Furthermore, the photographer may contribute one or more image profiles to a database of image profiles collectively created by a number of photographers. Optionally, a database of image profiles may be compiled or complemented by harvesting “metadata” associated with photographs that are publicly displayed and/or otherwise shared, for example online.

Moreover, although this description primarily characterizes image profiles as records of actual photographic events (e.g. a photograph, or videographic still, etc., that was actually taken), various software applications have been developed that simulate, for example, virtual, computer-generated environments, in which the combined lighting effects of a variety of ambient lighting conditions and/or lighting devices on a subject may be predicted. Some of these applications are more complex and/or robust than others, and may thus simulate a considerable set and variety of variables, and as such may serve as examples for photographers wishing to replicate a similar lighting condition. As such, an image profile may alternatively include information related to such a virtual photographic setup or photographic environment, even those that may have no real-world counterpart.

An image profile may further include additional information related to the aforementioned data, such as instructional text, schematic illustrations, and so forth, to assist a user in emulating one or more aspects of the corresponding photographic setup in order to emulate the example photograph. Such additional information may have been provided in various manners, such as by the photographer who took the photograph, by another photographer reviewing the information related to the photograph, by software configured to translate certain data into an output in the form of a schematic illustration, one or more other sources, or some combination thereof.

The several example imaging systems described herein differ from one another primarily in terms of the database of image profiles and the manner in which such a database is accessed (i.e., the location of the database, how the database is searched, how information is retrieved therefrom, etc.).

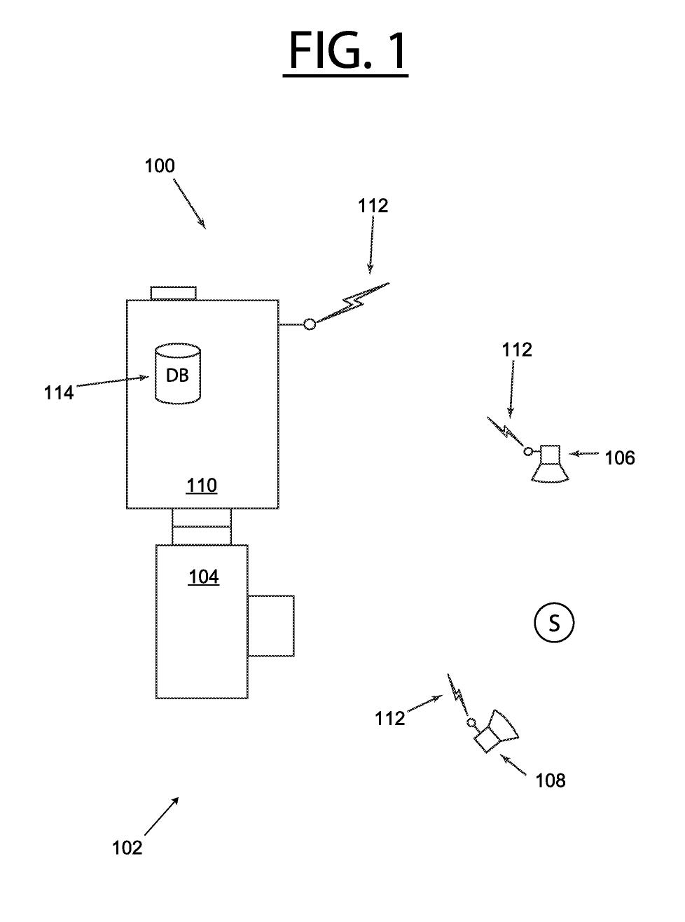

For example, in FIG. 1, a schematic view illustrating an example photographic system designated generally as 100, the system is shown in an imaging environment 102 and includes a camera 104 and two flash devices 106, 108 set up remotely from the camera. The various devices of imaging system 100 are arranged with respect to a photographic subject, designated at S, for image acquisition of the subject by the imaging system. Thus, for the imaging environment 102, example imaging system 100 is a camera system, although in other settings the imaging system may be a videographic system (and thus may include an imaging apparatus in the form of a video camera, and so forth), or any system in which one or more devices or pieces of imaging equipment are operable to acquire an image of a subject.

Camera 104 is shown to have a first illustrative embodiment of a commander device 110 coupled thereto, such as via the hotshoe connector of the camera, or in some other manner. The commander device 110 in the example photographic environment 100 may function as, or incorporate, a communication device that is adapted to facilitate communication between the camera and the two flash devices, such as by wireless signals 112, which may be radio signals. Examples of wireless communication methods and devices configured to establish and/or facilitate wireless communication by radio signals in a camera system are disclosed in Applicant's co-pending US Patent Application Pub. Nos. US20090129765, US20100008658, US20100124412, and US20100209089, the complete disclosures of which are hereby incorporated by reference.

In the example photographic system 100, the illustrative embodiment of commander device 110 includes a database 114. As noted above, the database 114 is a database of image profiles, each of which includes an image of an example photograph and data related to the example photograph, the data including one or more photographic settings, or values thereof, for taking the example photograph.

Database 114 may be searched or otherwise accessed, such as by a user of the photographic system 100, in a number of ways. In one example, information about the environment 102, such as information about the flash devices 106, 108, information about the camera 104, and possibly other information, may be inputted to the commander device 110. As to the information about the photographic devices, the commander device 110 may retrieve such information from the devices themselves, such as during one or more communications with the various devices. Such information may include data such as make and model of the device, various capability and/or setting parameters, and so forth. As to other information, the commander device may (but is not required to) be provided with a user interface to facilitate receiving such input from a user. Optionally, some or all of the information regarding the various devices of the photographic system may be manually provided by the user. In some embodiments, the database, or another database or set of data resident in local memory or otherwise accessible to the commander device, may also include a set of technical specifications that may be accessed for a variety of photographic equipment, such as if provided with a model number of a device, and so forth. The information may be used by the commander device to query the database, such as to return a collection of image profiles of example photographs consistent with the capabilities of the present imaging system.

In another example, a query may be generated from values measured in the photographic environment 102. For example, although not specifically shown, a light metering device (resident in the camera 104, for example) may be used to measure the amount of ambient light in the photographic environment 102, or reflected off of the subject or a part thereof (such as the gown of a bride). The database may be queried to retrieve a collection of image profiles of example photographs having the same or a similar lighting condition. Another example may include a dimensional measurement in the photographic environment, such as the distance separating the subject S from a wall, which may be determined in any suitable manner, such as via a laser range finder or otherwise. Image profiles matching a query based on this measurement, such as in which a subject was within a certain distance from a wall, may be returned from searching the database.

Optionally, multiple queries may be made, such as sequentially to narrow down a set of search results, or simultaneously, and so forth, and further may be performed at a user's option or automatically, or some combination thereof. The end results may correspond to a set of example photographs that the photographer may be capable of emulating with the equipment on hand and in the current situation.

The image profiles resulting from one or more search queries may be made available to the user in any suitable manner. For example, the commander device may present images of the corresponding example photographs via a display module that includes a display on an exterior portion of the commander device, on a display of the camera, and so forth, for example that the user may scroll through and/or select, such as via controls on the commander device 110 and/or camera 104. The image(s) presented may correspond to the capabilities of the display or display module, and may therefore be simplified, monochromatic and/or low-resolution images, and so forth.

Once an example photograph is selected, the commander device 110 may retrieve the image profile corresponding to the selected example photograph, or some of the information therefrom, and present some or all of the retrieved information from the image profile to the user, such as text instructions or schematic diagrams, etc., instructing the relative placement of the camera 104, and/or one or both of flash devices 106, 108, in relation to the subject S, including specifying a position and/or an orientation in three-dimensional space relative to some reference point or plane, any modifiers (such as a diffuser for a flash device), etc. The text instructions and schematics, and so forth, may correspond to instructions and schematics already present in the image profile, or the commander device, such as by means of a processor configured to execute software instructions stored in a memory, may produce such information based on data in the image profile.

The user may indicate to the commander device 110 in any suitable manner that the devices of the imaging system are set up as instructed, and then proceed to image acquisition, such as by activating the shutter button on the camera. Optionally, pressing the shutter button may itself serve to indicate that the imaging system has been prepared as per instructions. Meanwhile, the commander device 110 may have determined, from information in the image profile, at least one value for an adjustable parameter of one of the devices of the imaging system 100 to emulate the photographic setup for taking the example photograph. In other embodiments, this determination may not be performed until a user indication that the imaging system has been properly set up, and/or even until the shutter button has been pressed. Some determinations may consider information about the environment that has been inputted to the commander device, such as to account for a foggy condition, and so forth. As noted above, the parameters may include, for example, flash intensity values for one or both flash devices, which may be absolute values, a ratio of values, or otherwise, other flash settings, such as duration, etc. Parameters for the camera may include standard camera parameters such as f-stop, ISO value, shutter speed, other camera parameters, and so forth.

Optionally, the “instructions” step may be bypassed, such as in cases in which the photographer desires to proceed with the devices of the photographic system in their current positions/orientations. In such cases, one or more search queries may be based on the current positioning and/or orientation of the devices of the photographic system, and/or the commander device may consider such factors in determining values for respective parameters of the devices.

The commander device 110, such as via a transmission module (for example, a radio module consisting of an antenna powered by radio circuitry, or an optical output such as an LED controlled by associated circuitry, and so forth), transmits one or more command signals, such as by means of wireless signals 112, to the device(s) for which one or more values have been determined for respective parameters of the device(s). Examples of wireless communication methods and devices configured to establish and/or facilitate wireless communication by radio or optical signals in a camera system, to prepare and activate flash units by radio, and so forth, are disclosed in Applicant's aforementioned US20090129765 and US20100008658. Using these or similar methods, the commander device may determine a proper format and timing of the various transmissions to ensure that the respective devices will receive the command signals and set the corresponding parameters thereof to the values instructed in the command signals prior to image acquisition. For example, in embodiments in which flash intensity values are determined by the commander device, the flash intensity values may be communicated to the flash devices prior to or in conjunction with a shutter activation command. Optionally, flash intensity values may be communicated immediately before, or a relatively longer time period before, or effectively simultaneous with a trigger command initiated by the camera to take the photo and emit a flash.

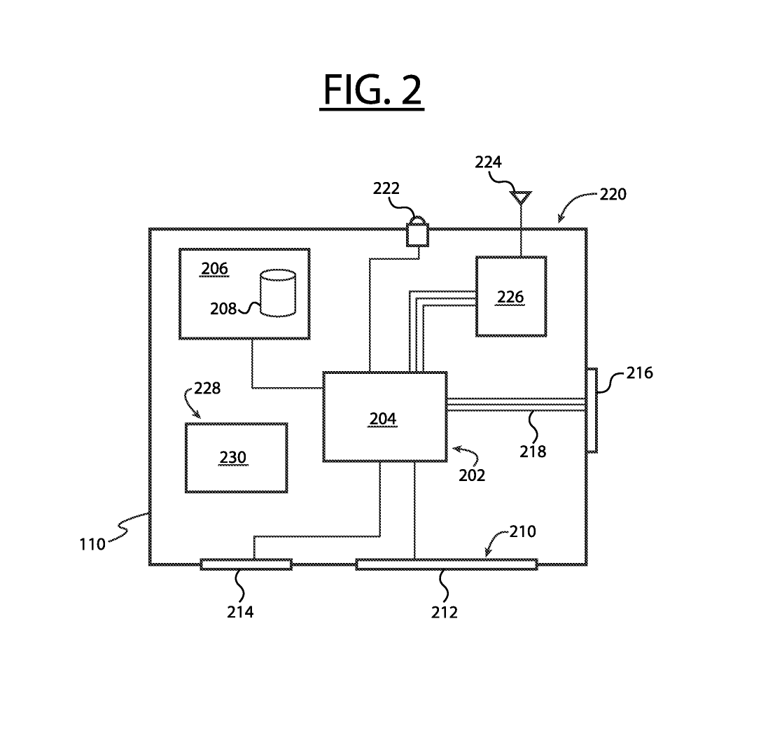

FIG. 2 schematically indicates an example layout of various structural and functional components of the illustrative embodiment of commander device 110. In the illustrative embodiment, the device includes a command module 202 in the form of processing means 204 configured to carry out various processes, calculations, timing, and data manipulations, as necessary to achieve the functions described herein. For example, processing means may be configured to access a database of image profiles by forming queries and retrieving results therefrom, determine values for adjustable parameters of devices of the photographic system with which the commander device is used, format command signals, and so forth. Processing means 204 may include a clock source, such as a crystal clocking oscillator or otherwise, either internal to a microprocessor of the processing means, or external to feed a signal thereto, and so forth. A suitable processing means may be a processor such as a Microchip PIC845K20, available commercially from Microchip, Inc. Processing means 204 may optionally include other components and/or modules, multiple iterations thereof, and so forth, and may be connected electrically via wires and/or a printed circuit board (PCB), as known in the art, to various other components of the commander device. Of course, processing means 204 may include multiple processors arranged in a parallel processing configuration, or a single, central processing unit (CPU), as desired.

Processing means 204 may incorporate or may otherwise communicate with a memory 206. For example, processing means may be programmable to execute instructions stored in memory 206. Memory 206 may include memory local to the device 110 as well as removable memory such as an SD memory card, a flash memory device, and the like, and may include read-only memory (ROM), such as EEPROM, etc., and/or random access memory (RAM). A basic input/output system (BIOS) may be stored in ROM, such as may contain the basic routines to transfer information among elements of the device, such as via a bus and/or various other signal lines and/or via a PCB, according to known methods of circuit design. Memory 206 may provide nonvolatile storage for processor-readable instructions, data structures, program modules, a means for firmware updates for command module 202, and other data (such as, but not limited to, image files, video files, music files, and so forth) for use by the commander device 110. Specifically, in the illustrative embodiment, a database 208 of image profiles is resident in on-board memory 206.

Commander device 110 is also shown to include a display module 210 electrically connected to command module 202 in the form of a touchscreen display 212 that is configured to visually display various images (such as images of example photographs), text (such as instructions, options, and so forth), and other indicia (such as icons for various applications and features), as a matter of design choice, and accept user-provided input. Other embodiments may include a display module in the form of a comparatively simpler display, such as one configured for low-resolution or monochromatic readout, one that is not configured to accept user input via the display, etc. Optionally, commander device may include one or more user input controls 214, which may include any standard input features and devices such as knobs, dials, buttons, switches, a keyboard, and so forth, instead of or in addition to a touchscreen display. Although not shown, commander device 110 may include an additional processing unit, such as a graphics processing unit (GPU) to format and feed appropriate display graphics to display module 210.

In the illustrative embodiment, commander device 110 is configured to removably couple with a camera, such as camera 104, via a hotshoe connection, and thus is provided with a hotshoe connector 216 configured to mate with a corresponding hotshoe connector on the camera housing. As is known in the art, a hotshoe connector provides a mechanical as well as an electrical connection between components, such as may be used for passing electrical communication signals back and forth between devices connected thereby, such as via signal lines 218 between the hotshoe connector and the processing means 204.

Optionally, although not required to all embodiments, the commander device may be adapted to transmit information and other data by means of one or more data ports or connection interfaces in addition to a hotshoe connector. Examples may include a USB port to operate in any suitable USB mode including a host mode, a device mode, an on-the-go mode, etc., a synchronization port, an NV port for transmitting one or more of a video and an audio signal (such as an HDMI port, a video port configured according to various standards such as component video, RGB, DVI, VGA, etc). In some embodiments, the commander device may include multiple iterations of the above. For example, a commander device may include two hotshoe connectors, such as to fit between a camera and an attached flash device.

Commander device 110 includes a transmission module 220 configured to transmit a command signal, such as from command module 202, to devices of the photographic system with which the commander device is used. The configuration of the transmission module may be chosen as suitable to the type of communication that the photographic devices are configured to receive. For the sake of illustration, commander device 110 is shown in FIG. 2 to be equipped with two wireless transmission means: optical, via an optical emitter shown as an LED 222, and radio, via an antenna element 224 powered by radio circuitry 226. Examples of appropriate construction, selection, and arrangement of radio circuitry 226 are disclosed in Applicant's aforementioned US20090129675, US20100209089, and so forth. Radio circuitry 226 may optionally include various filtering, electrostatic discharge, and/or other components as suitable. In some embodiments, antenna element 224 and/or radio circuitry 226 may be adapted to facilitate reception of radio signals as well as transmission thereof.

The commander device may further include a power source 228, such as an internal power source in the form of a battery 230, or may be externally powered, such as a conventional AC power cord, a USB cable, and so forth. Although not specifically shown, commander device 110 may include other components, such as various resistors, capacitors, transistors, regulators, clocking elements, data bus lines, signaling lines, and so forth, as known in the art of electronic circuit design. Of course, other embodiments of a commander device constructed according to the present disclosure may include a greater or lesser quantity of any such component than as discussed above with respect to the example embodiment shown in FIG. 2. For example, as discussed below, other embodiments of a commander device may not include a database of image profiles resident in on-board memory.

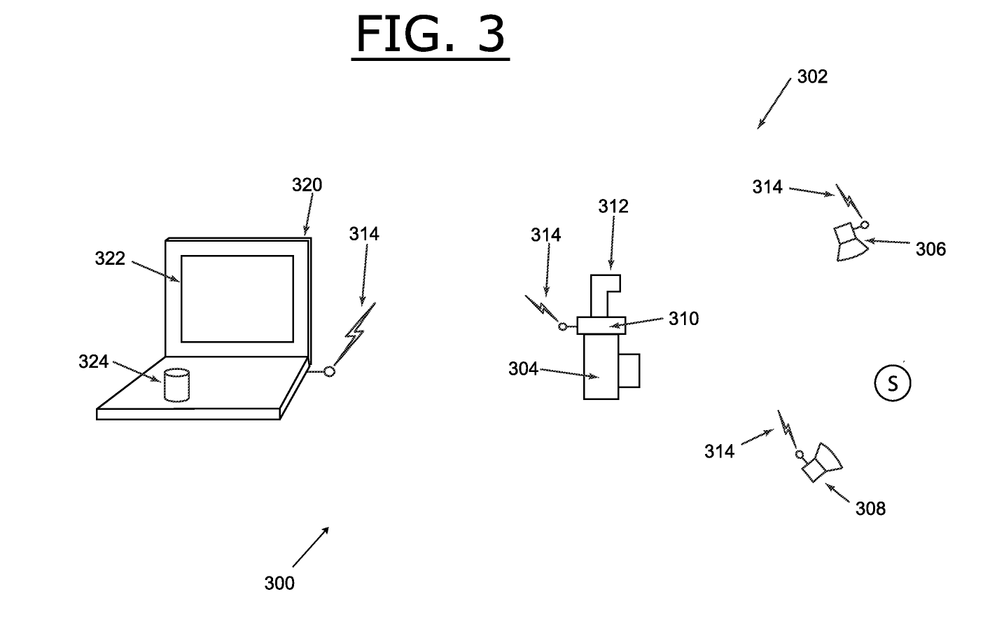

In FIG. 3, for example, which schematically illustrates a second example imaging system 300 for use in a photographic environment 302. System 300 includes a camera 304, and two remote flash devices 306, 308, arranged with respect to a photographic subject S. A commander device 310 is shown to be coupled to the camera 304 such as by means of a first hotshoe connection, and a local flash device 312 is shown to be coupled to the commander device 310 such as by means of a second hotshoe connection. As in the first example photographic system, the commander device 310 of system 300 may function as, or incorporate, a communication device that is adapted to facilitate communication between the camera and the two flash devices, such as by wireless signals 314, which may be radio signals.

Commander device 310 in FIG. 3 is shown to be in wireless communication with a computing device 320, shown as a laptop computer, that includes a display 322. Instead of commander device 310 including a database of image profiles, computing device 320 is shown to include such a database 324, such as may be stored in memory of the laptop computer. The wireless communication between the commander device and the computing device, which is also shown as wireless signals 314, may use the same wireless protocol as the wireless communication between the commander device and the various photographic devices, a compatible wireless protocol, or a different wireless protocol altogether. For example, the wireless communication between the commander device and the computing device may employ a WiFi protocol, whereas that between the commander device and the various photographic devices may employ another protocol, such as another IEEE 802.11-based protocol, ZigBee, another extension of the IEEE 802.15.4 standard, and so forth. As such, commander device 310 may incorporate multiple transmission and/or reception modules, and requisite circuitry and/or components, to format and/or resolve such communications, or even function as a bridge between incompatible wireless communication protocols. Example wireless camera system bridging methods and apparatus are disclosed, for example, in Applicant's co-pending U.S. patent application Ser. No. 13/212,988, the complete disclosure of which is hereby incorporated by reference.

In the system shown in FIG. 3, the database 324 may be queried as in that illustrated in FIG. 1, such as by means of the commander device using various information about the photographic devices of the photographic system 302 to filter the database. However, a user may additionally or alternatively search database 324 by means of a keyboard (not shown) of the computing device, which may provide a more robust or more user-friendly interface than that of a display module of the commander device. In one example, both user-provided and commander device-provided search criteria are used in order to generate a set of image profiles corresponding to example photographs that may be emulated with the devices of photographic system 300 in photographic environment 302. A user, such as a photographer, or even the client, may use the computing device to select, from the set of image profiles, an example photograph to emulate. The selection may be implemented by the computing device then transmitting all or some of the data from the image profile to the commander device, by manually entering a unique identifier corresponding to the selected image profile (such as a serial number output by the computing device) into the commander device, which may then retrieve some or all of the data from the image profile, and so forth. Instructions, schematics, and other information, when available, may be provided on the display 322 of the computing device, which may be configured to display images in higher resolution or in a more complex color palette, etc., as compared to a display module of the commander device. Optionally, such information may be presented via a display module of the commander device instead of or in addition to the display 322 of the computing device. The various processing steps based on the information in the image profile, such as determining one or more values (such as flash intensity values, or ratios, etc.) for one or more of the devices (such as one or more of the flash devices) of the photographic system, may be performed by an on-board processing means resident in the commander device 310, by a processor in the computing device 320, or both. In the illustrated implementation, corresponding command signals may then be transmitted by the commander device 310 to the various devices, or directly or indirectly from the computing device 320.

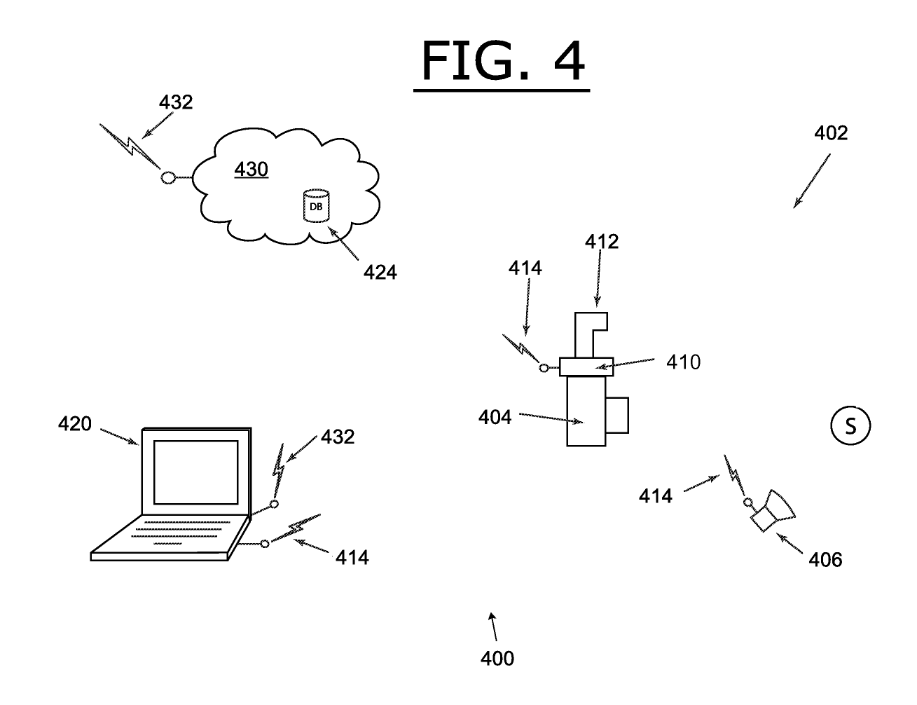

In FIG. 4, which schematically illustrates a third example imaging system 400 in a photographic environment 402, with system 400 including a camera 404, one remote flash device 406, a commander device 410 coupled to the camera and also to a local flash device 412 all arranged with respect to a photographic subject S and configured to communicate via wireless signals shown at 414, a communication network is extended even further. Specifically, a computing device 420 in communication with commander device 410 via wireless signals 414, may access a database 424 of image profiles, which may be stored on a computing device such as a remote server, made available via a network 430 such as the Internet. Communication with network 430 is shown to be accomplished by means of wireless signals 432, which may be formatted using a different wireless protocol than wireless signals 414 used in communicating with the various photographic devices of system 400. In this system, commander device 410 may query and/or otherwise access the database via Internet-enabled computing device 420, which may simply act as a passive communication relay configured to translate communications from the commander device into a protocol suitable for Internet communications. In another implementation, the computing device may query and/or otherwise access the database in addition to or instead of the commander device, as in the environment shown in FIG. 3. In such an implementation, a user remote from the photographic environment may optionally access the database via another computing device (not shown), for example to provide a remote client a way to select one or more example photographs that the client desires the photographer to emulate.

A database of image profiles, such as any of databases 114, 324, 424, and so forth, may consist of multiple databases, or portions of a database. In some embodiments, a single database may be stored in multiple locations, or multiple locations may store related databases. For example, a first database may include a collection of images of example photographs and a unique identifier for each, such as a serial number, whereas a second database may include a full image profile for each example photograph, including all of the associated information discussed above (e.g., photographic setup for taking the example photograph, settings for various devices in such a setup, other information such as instructions and schematics and the like, etc.). Moreover, information from the image profiles in the second database may be retrievable using an identifier such as a serial number associated with an example photograph of the first database. The use of relational databases may reduce a memory footprint needed to store information used by part of the processes and methods disclosed herein.

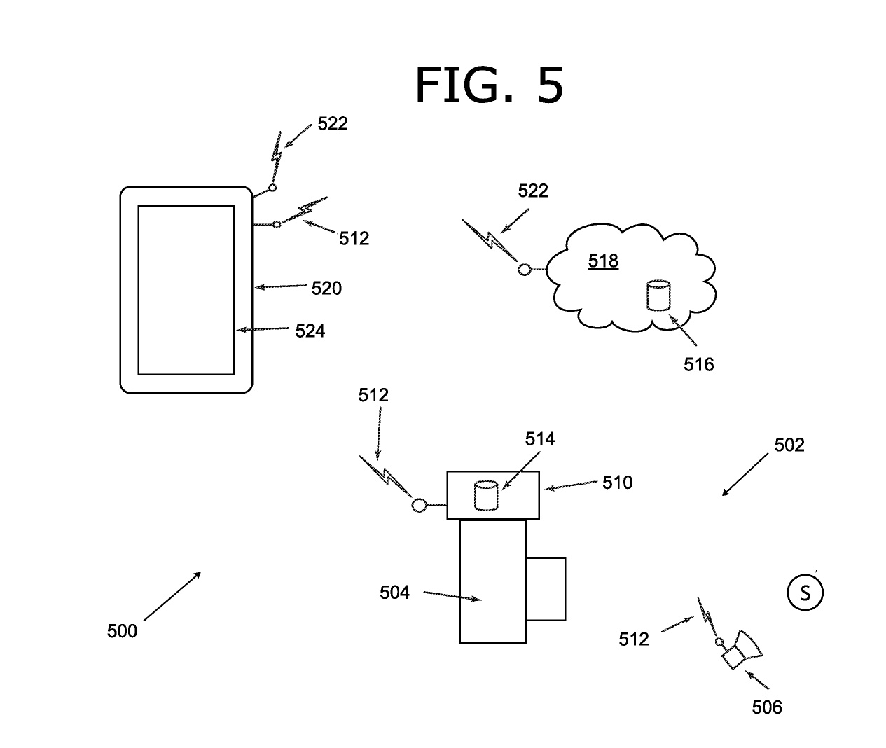

An example embodiment in which this concept may be implemented is shown in FIG. 5, which schematically illustrates a fourth example imaging system 500 in a photographic environment 502 in which system 500 includes a camera 504 and a remote flash device 506 arranged with respect to a photographic subject. A commander device 510 is shown coupled to the camera via a hotshoe connector, and communicates with the flash device via wireless signals 514. A first database 514, which may contain information referencing a library of example photographs, is resident in commander device 510. For example, first database 514 may include the flash intensity value(s) used in the photographic setup for a set of example photographs, and a unique identifier for each example photograph, such as a serial number.

A second database 516 is shown to be accessible via a network 518 such as the Internet, and as such second database may be stored on one or more servers available via network 518. Second database may include additional information related to the set of example photographs of first database 514, such as a full image profile corresponding to each, which each may include or be associated with the same unique identifier used in the first database 514.

System 500 also incorporates a communication device 520 that is configured for communication both with the commander device 510, via wireless signals 514, and with the second database 516 via network 518, via wireless signals 522. As noted above, the wireless signals 514, 522 may be formatted using different wireless communication protocols. Communication device 520, which may be a smartphone, a tablet computer, another computing device, and so forth, is shown to include a display 524, which may be a touchscreen display. Optionally, communication device may be provided with various input features and devices such as a keyboard, etc.

An example use of the various components of system 500 may be as follows. Information about photographic system 500 may be provided to the communication device 520 manually by a user and/or automatically via commander device 510. Additional information about the photographic environment 502 may also be provided, such as manually by a user, by measurements taken by devices of system 500, etc. The inputted information may be used to query the second database 516, yielding a collection of images of example photographs that may be scrolled through or otherwise viewed on the display 524 of the communication device 520. The display 524 may be a comparatively high-resolution display capable of showing even slight color differences and other subtleties of an example photograph. A selection of a particular example photograph may be made via communication device 520, such as via a touchscreen display or other input means. Once selected, the display 524 may present additional information related to the example photograph, such as may be retrieved from the image profile associated therewith in the second database 516. Such information may include instructions, schematics, and so forth.

For image acquisition of the subject S by photographic system 500, for example after the photographic equipment thereof is set up according to any instructions or other information provided, the identifier corresponding to the selected example photograph may be provided to the commander device 510, such as input manually by a user, or transmitted wirelessly from the communication device 520 (either automatically or when instructed by the user), or otherwise. The commander device 510 may then retrieve, using the identifier, the flash intensity value(s) associated with the example photograph from the on-board first database 514, and proceed to transmit suitable command signals 512 to the flash device 506 to set its flash intensity value accordingly. Optionally, such as to ensure that the correct identifier is used and/or that the correct flash intensity value(s) are retrieved, first database 514 may further include a low-resolution image of each example photograph, for example to display on a display module (if provided) of the commander device 510 after being provided with an identifier.

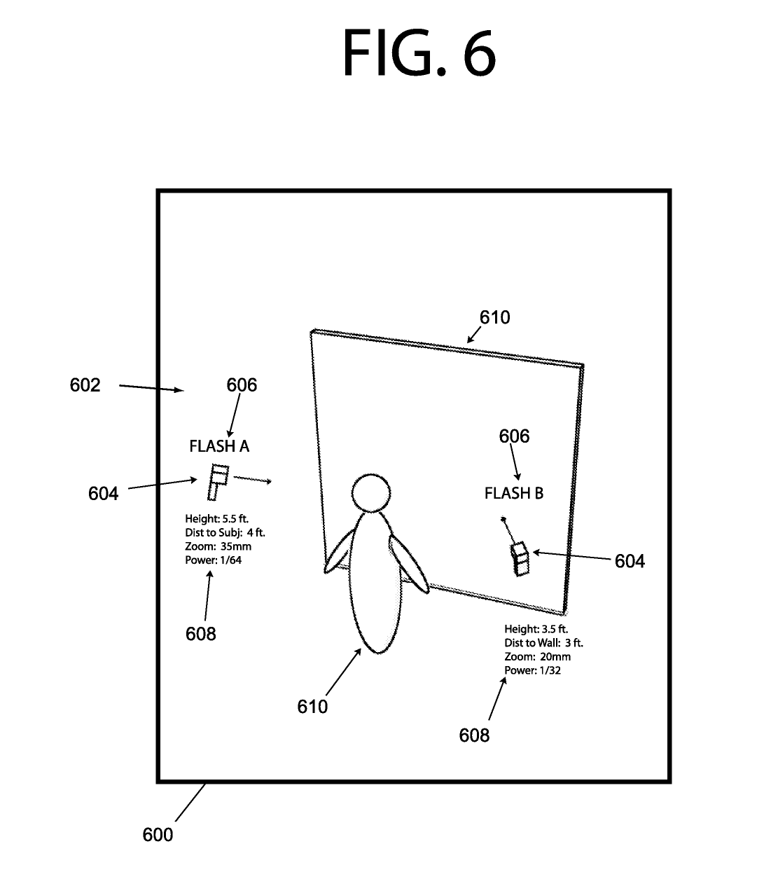

FIGS. 6-9 illustrate various types of schematic diagrams that may be presented to a user upon selecting an example photograph, such as on a display of a commander device, of a computing device, of a communication device, and so forth, such as explained above. As noted above, one or more schematic diagrams may be included in an image profile or generated based on data in an image profile. Diagram 600 of FIG. 6 is shown as a simplified line drawing representing a three-dimensional view of a photographic setup 602, which may include various representations 604 of photographic devices such as flash devices, along with various captions 606 (e.g., “FLASH A,” “FLASH B”), and/or additional text information 608 (e.g. relating positional details and/or settings), superimposed on the diagram. A diagram may further include various representations 610 of elements of a photographic environment, such as a subject, a background wall, and so forth, and may be presented in a manner so that a user may approximate the relative positions and/or orientations of the various represented devices and elements in the actual photographic system and environment in use.

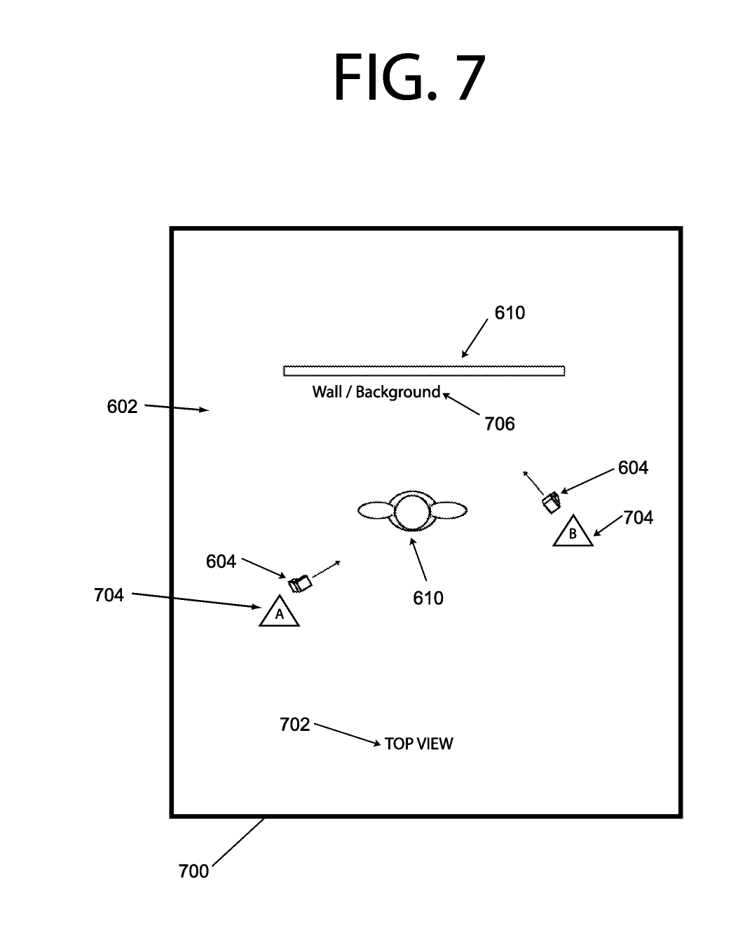

Diagram 700 of FIG. 7 may represent a top view of the photographic setup 602 of diagram 600, such as to allow a user a better indication of relative spacing in two dimensions of the various devices/elements of the setup. For clarity, the diagram may include a label 702 superimposed on the diagram indicating the view depicted in the diagram (e.g., “TOP VIEW”). Also, the two representations 604 of the flash devices are accompanied by icons 704 instead of superimposed captions and information. Such icons may, such as on a touchscreen display, be convertible to text information upon being selected by a user. Optionally, such as shown with respect to the representation 610 of the wall behind the subject, some representations may be accompanied in different views with explanatory text 706.

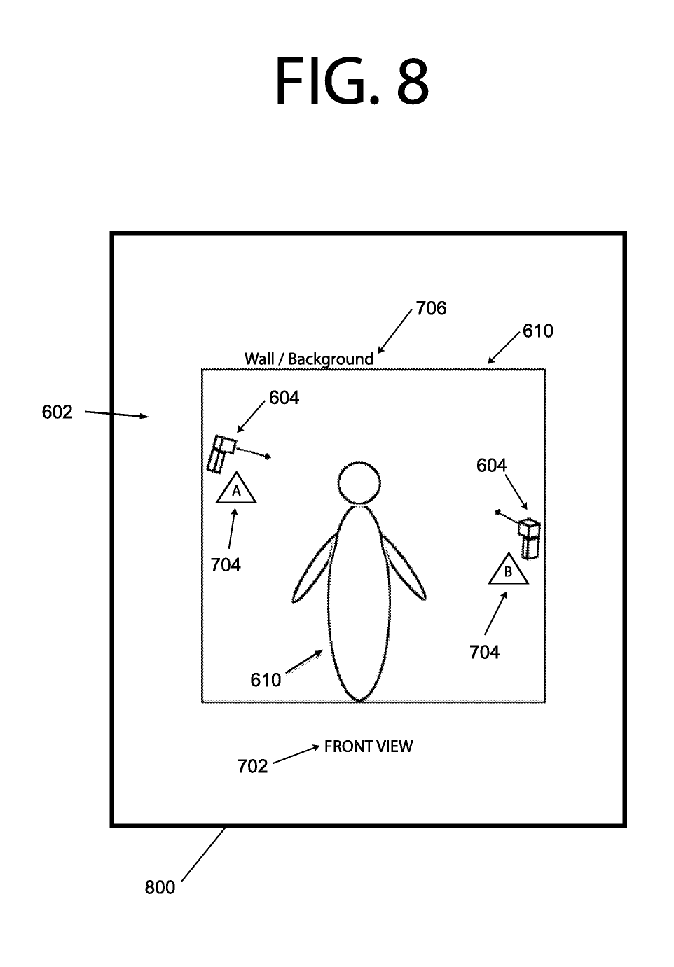

In a somewhat similar manner, diagram 800 of FIG. 8 may represent a front view, as indicated by caption 702, of the photographic setup 602 of diagram 600, to allow another indication of relative spacing in two dimensions. Optionally, a user may be provided with the ability to shift between the various views presented in diagrams 600, 700, and 800, such as by means of an input like a button, etc., or by touching a touchscreen display in a certain location.

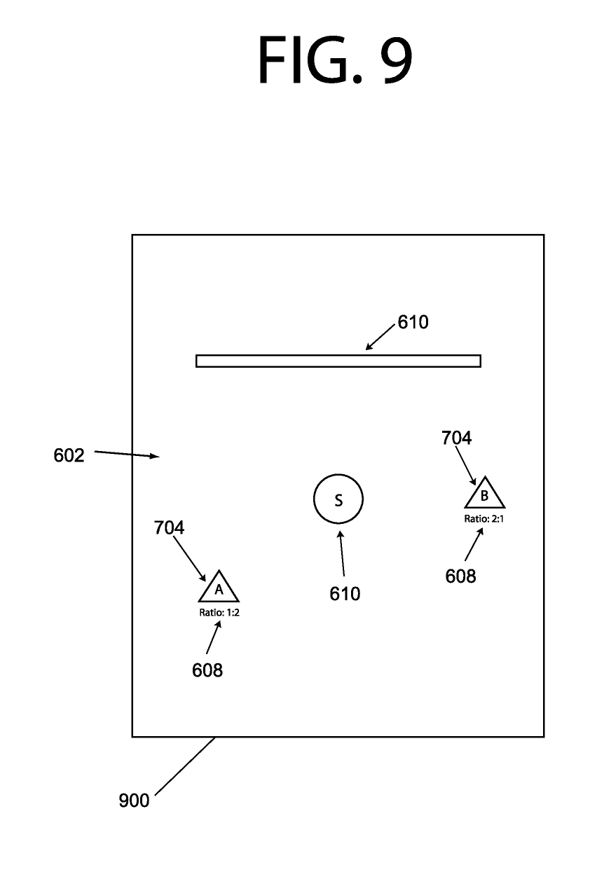

Finally, FIG. 9 shows a diagram 900 that may represent a top view of the photographic setup 602 of diagram 600, and which presents an even more simplified view of the setup. For example, diagram 900 does not include a label indicating the view or captions for the representations 610 of elements, and indicates the devices (e.g., flash devices) via icons 704 accompanied with text information 608 which, in this case, indicates the flash intensity ratio for each flash device.

In other embodiments, schematic diagrams may include a greater or lesser amount of information, presented in different manners, and so forth, which may be a matter of design choice and/or according to methods of effective information display, etc. Furthermore, the schematic diagrams may be optimized for the type of display upon which they will be presented. Diagrams 600, 700, 800, and 900 are all shown as line drawings that may be suitable for a monochromatic display, but other schematic diagrams may incorporate use of differently shaded and/or colored indicia, more complex graphics, and so forth.

As mentioned above, in many embodiments, information about the photographic system in use may be inputted to a commander device or other device configured to access a database of image profiles, such as may be automatically provided by a commander device by obtaining such information directly from the devices, by a user manually entering make a model of various devices (and/or various parameters thereof), and such information may be used to query the database to return a set of example photographs that may be consistent with the abilities of the present photographic system. In some embodiments, information related to the capabilities and parameters of a wide variety of photographic devices may be stored in memory accessible to a commander device.

However, it is common for many photographers, especially hobbyists and/or professional photographers, to own or otherwise have access to a wide variety of gear that may be available for use in a photoshoot. As such, an example method of emulating an example photograph with an imaging system may include accepting, for example by a commander device, an inventory of devices available for inclusion in the imaging system. Such a method may accordingly further include identifying, such as by the commander device, one or more devices from the inventory to include in the imaging system for image acquisition of the subject. This identification may be provided along with, or prior to, any instructional data presented to the user.

The identification of one or more devices to include in the imaging system may be presented as one or more additional devices to incorporate into an existing imaging system, one or more substitute devices to exchange with one or more other devices that are already in an existing imaging system, and so forth. Suitable substitute devices may be those whose capabilities and/or parameters more closely match those in the example photographic setup, which may be determined, for example, by determining the extent to which a particular parameter or set of parameters of two or more devices available for inclusion in the imaging system (of which one may already be included in the imaging system) may differ from that of a device used in an example photographic setup, and recommending the “closest match,” i.e. the one that differs less. An example parameter may be a maximum flash intensity value of a flash device. In another example, equipment that may be modified to have similar capabilities to that in an example photograph may be suggested, such as instructing the use of a fixed light with a low power bulb that the photographer may have on hand in place of a small fill light that was used in the photographic setup for the example photograph.

Optionally, substitution criteria may be set so that no substitute is suggested if a compared parameter differs by less than some predetermined threshold value. In other embodiments, substitution criteria may be biased to recommend a piece of equipment among functional equivalents that functions more efficiently, that is available for a lower cost, that is produced by a certain manufacturer, and so forth.

A somewhat analogous inquiry may be employed in a search query in which a database of image profiles is searched according to the capabilities of the imaging system in use and/or those of devices in an inventory of devices available for use with the imaging system. Briefly, an inquiry may compare devices that were actually used in the photographic setup used to take an example photograph with those in the imaging system and/or in an inventory of available devices. If an exact match is not found, the inquiry may then determine if any substantially functionally equivalent devices are included in either the imaging system or the inventory of available devices. One example may be an example photograph in which a Canon 580EXII flash device was used, and in which a photographer has a Nikon SB-900 flash device available for use. In this example, both flash devices have similar maximum and minimum flash intensity values; as such, if the inquiry is based on this criteria alone, the Nikon SB-900 may be identified as a suitable equivalent for the Canon 580EXII, and accordingly example photographs in which a Canon 580EXII was used may be included in the search results.

In embodiments that are adapted to consider an inventory of devices available for use, a photographer may store, maintain, and update several different inventory files, such as in the memory of a commander device, a communication device that may communicate with a commander device, and so forth. A selected inventory file may be used as the basis for a search query to return a set of example photographs that may be achieved using one or more of the devices in the inventory file (which may be further narrowed down in consideration of environmental parameters, etc.). Different inventory files may relate to different inventories that the photographer maintains, such as a first inventory of devices that the photographer leaves at his studio, a second inventory of devices that the photographer typically takes when traveling to a photographic shoot, a third that is available for rent from a photo supply store, etc.

Furthermore, a database of image profiles may be used in some embodiments to formulate a list of recommended photographic devices to use in order to achieve one, or several, example photographs, such as may be provided by an equipment supply or rental store in marketing various photographic packages, and so forth.

In the foregoing disclosure, the present invention has been described with reference to specific illustrative embodiments, systems, apparatus, devices, methods, processes, and other examples, and selected variants thereof. It will be apparent to those skilled in the art that various modifications and changes may be made, however, without departing from the scope of the present invention as set forth in the claims. The specification and drawings are provided for illustrative purposes, rather than to restrict or limit any aspect of the scope of the disclosure. The present invention is intended to embrace all such alternatives, modifications and variances that fall within the scope of the appended claims.

For example, the steps, actions, or events recited in any of the methods or processes disclosed and/or claimed herein may be executed in any order and may not be limited to the specific order presented. Additionally, components and/or elements presented and/or claimed in any system, apparatus, device, component herein may be assembled or otherwise operationally configured in a variety of permutations and accordingly may not be limited to the specific configuration(s) presented.

Further, benefits, other advantages, and solutions to problems or challenges may be described herein with regard to particular embodiments, however, any such benefit, advantage, solution, or any element that may enhance or cause any particular benefit, advantage, or solution to occur are not to be construed as critical, required, or essential features or components of the invention, nor should the claims be construed as exclusively addressing such benefits, advantages, or solutions.

I claim:

1. A method for emulating an example photograph with an imaging system adapted for image acquisition of a subject in an environment, the method comprising:
selecting an example photograph from a database of image profiles that each includes an image of an example photograph and information related to a photographic setup, including one or more settings for photographic equipment in the photographic setup, for taking the example photograph;
determining, from information in the image profile corresponding to the selected photograph, at least one value for a parameter of a device of the imaging system, to emulate the photographic setup for taking the example photograph; and
transmitting, to the device, a command signal configured to set the parameter of the device to the determined value.

2. The method of claim 1, wherein the device is a flash device, and wherein at least one of the determined values is a value for the flash intensity setting of the lighting device.

3. The method of claim 1, further including displaying one or more images of example photographs of one or more respective image profiles.

4. The method of claim 1, further including, prior to determining at least one value for a parameter of a device of the imaging system, accepting an inventory of devices available for inclusion in the imaging system.

5. The method of claim 4, further including identifying one or more devices from the inventory of devices to include in the imaging system for image acquisition of the subject, and wherein determining at least one value for a parameter of a device of the imaging system includes determining such a value for a parameter of the imaging system with the one or more identified devices included.

6. The method of claim 5, wherein identifying one or more devices from the inventory of devices further includes comparing the photographic setup for taking the example photograph with the inventory of devices and the capabilities thereof, and identifying devices having capabilities compatible with the photographic setup.

7. The method of claim 4, wherein selecting an image profile includes searching the database of image profiles using one or more search parameters, wherein the one or more search parameters relate to the inventory of devices available for inclusion in the imaging system.

8. The method of claim 1, further including, prior to determining at least one value for a parameter of a device of the imaging system, accepting information relating to one or more of the subject and another element present in the environment;
and wherein determining at least one value for a parameter of a device of the imaging system is at least partially based on the accepted information.

9. The method of claim 1, further including, prior to selecting an image profile, searching the database of image profiles based on the devices of the imaging system and the capabilities thereof to create a set of image profiles for which the photographic setup for taking the example photograph is compatible with the imaging system.

10. The method of claim 1, further including, subsequent to selecting an image profile, providing one or more instructions for arranging one or more devices of the imaging system relative to the subject.

11. A system for performing the method of claim 1.

12. A commander device to assist emulating an example photograph with an imaging system adapted for image acquisition of a subject, the commander device comprising:
a command module configured to:
retrieve information from an image profile corresponding to a selected example photograph from a database of image profiles that each includes information related to a photographic setup, including one or more settings for photographic equipment in the photographic setup, for taking the example photograph; and
determine, from the retrieved information, at least one value for an adjustable parameter of a device of an imaging system to emulate the photographic setup for taking the selected example photograph; and
a transmission module configured to transmit a command signal to the device that is configured to set the adjustable parameter to the determined value.

13. The commander device of claim 12, further including a display module configured to display one or more of an image of an example photograph and instructions related to setting up one or more devices of the imaging system relative to the subject.

14. The commander device of claim 12, wherein the commander device is configured to be removably coupled to an imaging apparatus of the imaging system.

15. A system to assist emulation of an example photograph with an imaging system having at least one device with an adjustable parameter used during image acquisition by the imaging system, the system comprising:
a database of image profiles, each image profile including an image of an example photograph and data related thereto, the data including one or more values of photographic settings for taking the example photograph;
selection means for searching the database and selecting an example photograph therefrom;
processing means for determining, from the data in the image profile corresponding to the selected example photograph, a value for the adjustable parameter of the at least one device of the imaging system that is consistent with the photographic settings for taking the example photograph; and
transmission means for transmitting a command signal configured to set the adjustable parameter of the at least one device to the determined value.

16. The system of claim 15, further including display means for displaying one or more images of example photographs.

17. The system of claim 15, wherein the transmission means is configured to wirelessly transmit the command signal one or more of optically and via radio, and in a manner perceptible to the device.

18. The system of claim 15, further including input means for accepting information related to one or more devices available for inclusion in the imaging system, and wherein the processing means is further configured to identify, from the accepted information, one or more devices to include in the imaging system for image acquisition of the subject.

19. The system of claim 15, wherein the processing means is further configured to provide one or more instructions for arranging one or more devices of the imaging system relative to the subject for image acquisition in a manner suitable to emulate the example photograph.

20. The system of claim 15, further including input means for accepting information related to one or more devices in the imaging system, and wherein the processing means is further configured to search the database of image profiles based on the accepted information thereof to create a set of image profiles for which the photographic setup for taking the example photograph is compatible with the one or more devices in the imaging system.
